(19) United States
(12) Patent Application Publication
(10) Pub. No.: US 2015/0307261 A1
(43) Pub. Date: Oct. 29, 2015

(54) CYCLIC PRESSING-DOWN GEAR ARRANGEMENT

(71) Applicant: HSU-HUI CHANG, New Taipei City (TW)

(72) Inventor: HSU-HUI CHANG, New Taipei City (TW)

(21) Appl. No.: 14/261,434

(22) Filed: Apr. 25, 2014

(51) Int. Cl. B65D 83/26; F16H 35/00

(52) U.S. Cl. CPC B65D 83/262; F16H 35/00; F16H 2035/006

(57) ABSTRACT

A cyclic pressing-down gear arrangement includes a first housing in which a stop is mounted and a press bar, a circuit control unit, and a second gear arranged in the first housing. The first housing is formed for fitting to a spray can having a spraying head. The press bar has a protrusion located above the spraying head and an elastic element having an end positioned against the stop. The circuit control unit is electrically connected with a motor having a spindle extending into the first housing and including a first gear mounted thereto. When the motor is activated, the first gear drives the second gear to cause a cam to drive the press bar down for activating the spraying head. When the cam is rotated to contact a switching element, the motor is shut down and the press bar is returned by the elastic element.

### (A) TECHNICAL FIELD OF THE INVENTION

The present invention generally relates to an automatic pressing-down device for a spray can, and more particularly to a cyclic pressing-down gear arrangement that effectively reduces power consumption.

### (B) DESCRIPTION OF THE PRIOR ART

Containers that are available in the market for containing therein fluid solution, such as a spray can containing a fragrance agent or a pesticide, can be classified in two types according to the pressing-down operation they adopt, one being such that a single shoot of spray is made for each pressing-down of an actuator of the spray can and the other being such that a continuous time-extended spray is made for each pressing-down of the actuator of the spray can. The spray can comprises, structurally, a can body on which a valve is mounted. A stem is fit centrally in the valve and an actuator is mounted to a top end of the stem. The actuator comprises a spray orifice formed therein. To operate, the actuator is pressed down by a hand to descend the stem for opening the valve so that the fluid solution filled in the can body is allowed to flow through the stem and spray out through the orifice of the actuator.

The conventional spray can is operated by human power to pressed won the actuator for opening the valve of the spray can to allow the fluidic content of the can, such as a fragrance agent or a pesticide, to spray out. The fragrance agent or the pesticide, once sprayed out, get evaporated and spread in the atmosphere. However, the bad odor of air or insects may repeatedly appear. When a user becomes aware of the appearance of the bad smell of air of insects and makes another spray of the fragrance agent or pesticide, the problems of the bad smell or insects may get serious already.

Referring to FIG. 1, an automatic spraying device is shown, in which gears a, b, c are operated to drive a sector gear d to press down a spray can e. When the sector gear d is pressed down to the bottommost position to have the spray can e make a spray, a spring arranged in a spray valve e1 springs back. This increases the pressing-down loading of a motor, inducing an increased resistance in the circuit thereof and thus significantly consuming a large amount of electrical power of a battery.

In view of the forgoing, the present invention aims to provide a technical solution to the above discussed problems.

### SUMMARY OF THE INVENTION

In view of the above problems, the present invention provides a cyclic pressing-down gear arrangement, which comprises: a first housing in which a stop is mounted, a press bar, a circuit control unit, and a second gear. The first housing is formed for fitting to a spray can having a top to which a spraying head is mounted. The press bar, the circuit control unit, and the second gear are arranged in the first housing. The press bar comprises a protrusion and an elastic element. The protrusion is located above the spraying head. The elastic element has an end positioned against the stop. The circuit control unit is electrically connected with a power supply, a motor, and a switching element. The motor comprises a rotation spindle that extends into the first housing. The rotation spindle comprises a first gear mounted thereto. The switching element is set at a predetermined location with respect to the press bar. The circuit control unit is provided with at least a first activation time point and is operable to activate the motor at the first activation time point. When the motor is activated, the first gear drives the second gear to cause the cam to drive the press bar down so that the protrusion presses the spraying head to have the spray can spray. When the cam is rotated to contact and trigger the switching element, the motor is shut down and the press bar is returned by a restoration spring force of the elastic element.

The cyclic pressing-down gear arrangement of the present invention is provided for using a first push member, a second push member, and a third push member to achieve three phases of pressing down in a cycle so that each time when a third gear drives the press bar to press down, the press bar does not continuously maintain the spraying head in a pressed down condition and is instead moving away immediately after pressing down by instantaneously separating from the spraying head, whereby the large electrical current induced in the prior art device can be omitted, allowing for extension of the service life of the batteries and thus achieving the purpose of saving electrical power.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a conventional automatic spraying device.

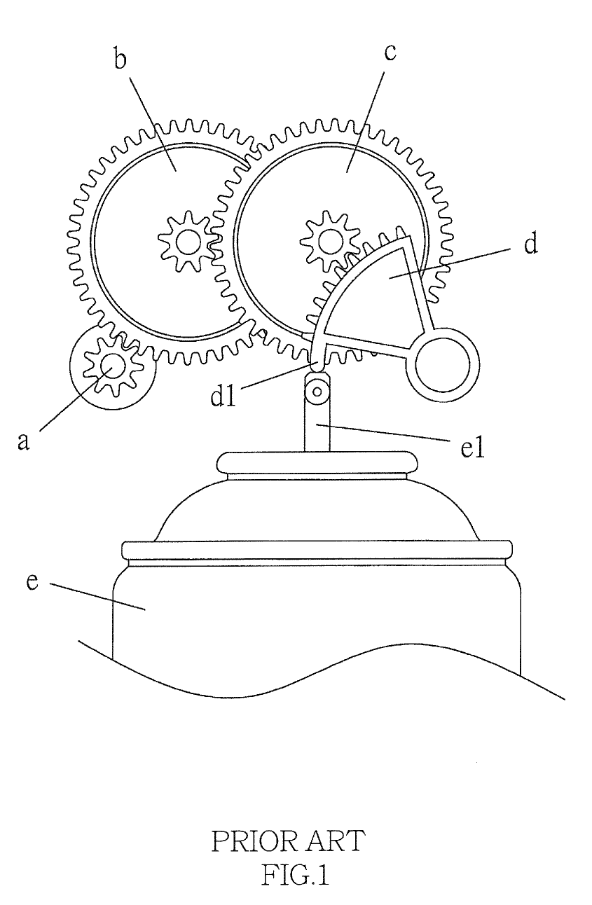

FIG. 2 is a perspective view showing a cyclic pressing-down gear arrangement according to the present invention.

FIG. 3 is an exploded view showing the cyclic pressing-down gear arrangement according to the present invention.

FIG. 4 is a further exploded view of FIG. 3 to show further details.

FIG. 5 is an assembled view of FIG. 3.

FIG. 6 is an exploded view of FIG. 5.

FIG. 7 is a schematic view illustrating a use of the cyclic pressing-down gear arrangement according to the present invention.

FIG. 8 is another schematic view of FIG. 7.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

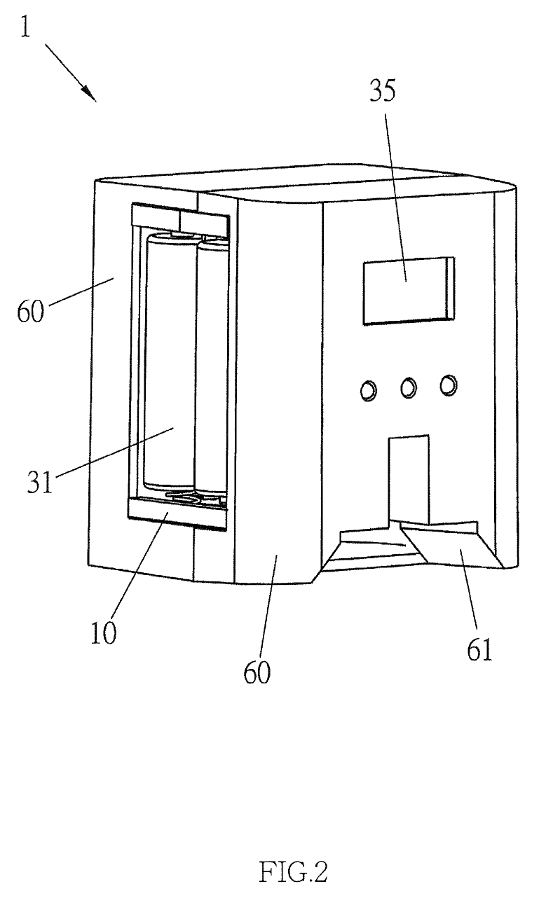

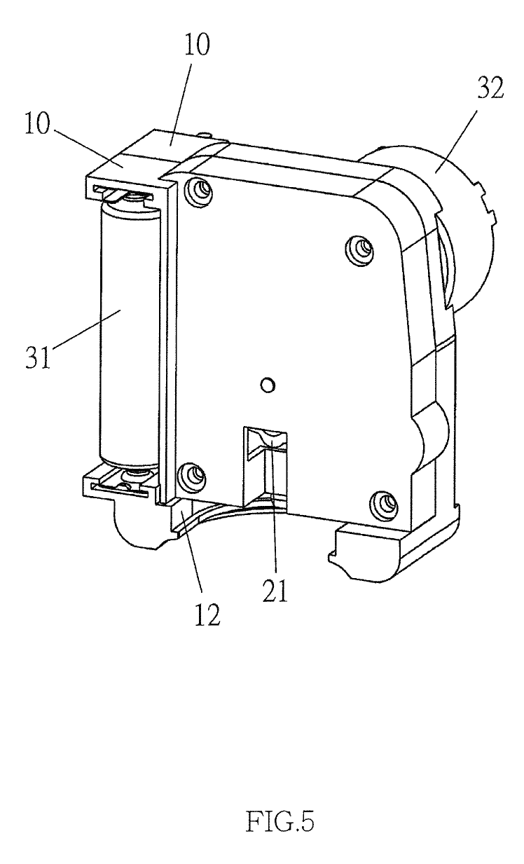

Referring first to FIGS. 2, 3, 4, 5, 6, the present invention provides a cyclic pressing-down gear arrangement 1. The cyclic pressing-down gear arrangement 1 of the present invention comprises: a hollow first housing 10, a press bar 20, a circuit control unit 30, a second gear 40, at least a third gear 50, and a second housing 60.

The first housing 10 has an end in communication with the outside. The first housing 10 comprises a stop 11 mounted therein at a predetermined position. The end of the first housing 10 that is in communication with the outside comprises a fitting opening 12 formed therein.

The press bar 20 is rotatably mounted in the first housing 10 and comprises a protrusion 21 and an elastic element 22. The protrusion 21 is formed on a bottom of the press bar 20. The elastic element 22 has an end supported on the stop 11.

The circuit control unit 30 is electrically connected with a power supply 31, a motor 32, and a switching element 33. The motor 32 comprises a rotation spindle 321. The rotation spindle 321 extends into the first housing 10 and the rotation spindle 321 comprises a first gear 34 mounted thereto. The switching element 33 is set at a predetermined location with respect to the press bar 20. The circuit control unit 30 is provided with at least a first activation time point and at least a second activation time point and is operable to activate the motor 32 at the first activation time point.

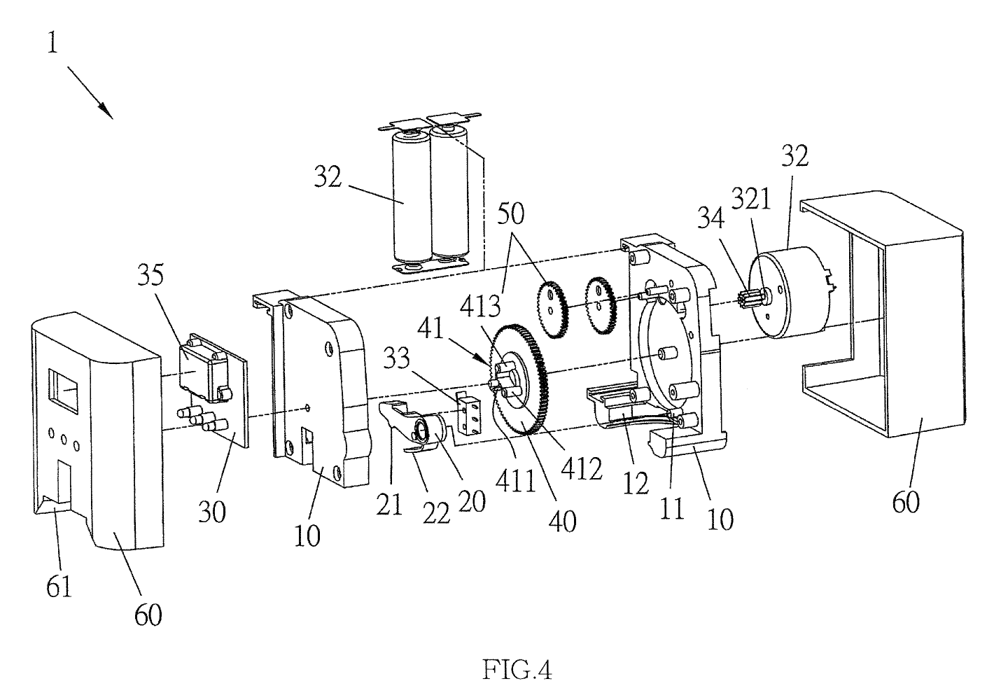

Referring to FIG. 4, the power supply 31 comprises, in the instant embodiment, two batteries, which are set at one side of the first housing 10.

The circuit control unit 30 also comprises a display element 35.

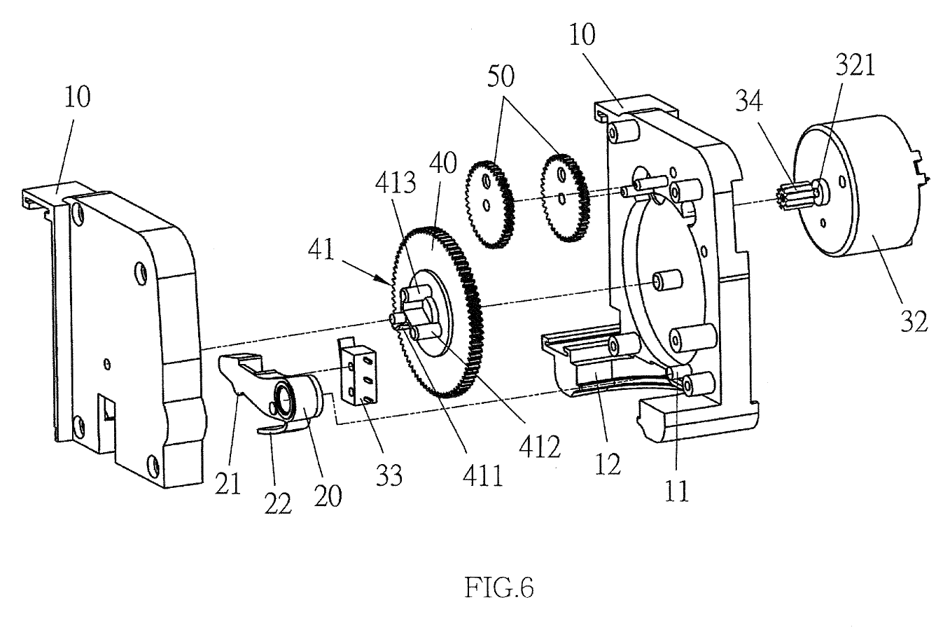

Referring to FIG. 6, the second gear 40 is rotatably mounted in the first housing 10 and mates the first gear 34. The second gear 40 comprises at least one cam 41 mounted thereto to be in contact engagement with the press bar 20. The cam 41 is mounted to a central portion of the second gear 40 and is raised therefrom. In the instant embodiment, the cam 40 is made in a Y-shaped that comprises a first push member 411, a second push member 412, and a third push member 413.

The first housing 10 comprises at least a third gear 50 mounted therein.

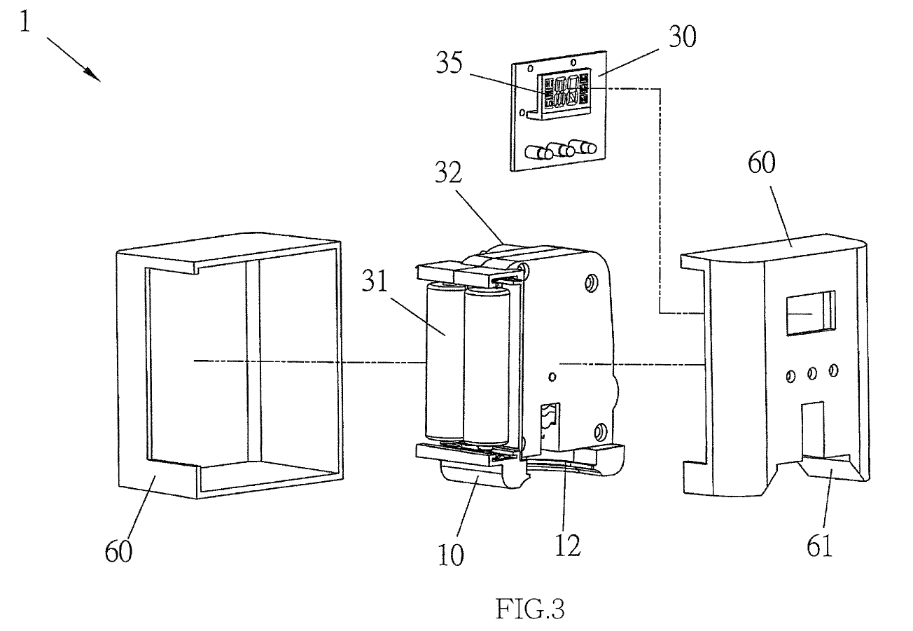

Referring to FIGS. 3 and 4, the first housing 10 is provided, on the outside thereof, with and enclosed by a second housing 60. The second housing 60 comprises a recess 61 formed to correspond to the fitting opening 12. The motor 32 and the circuit control unit 30 are received in a space between the first housing 10 and the second housing 60.

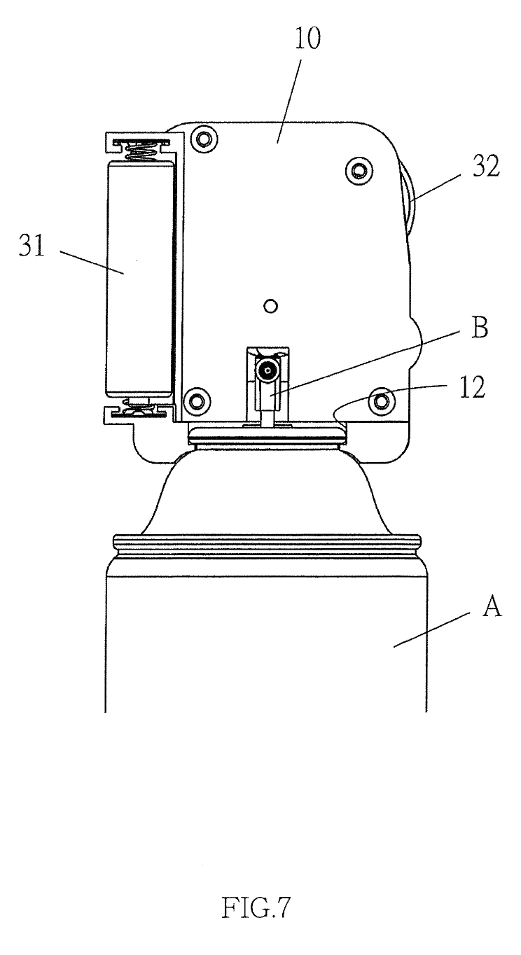

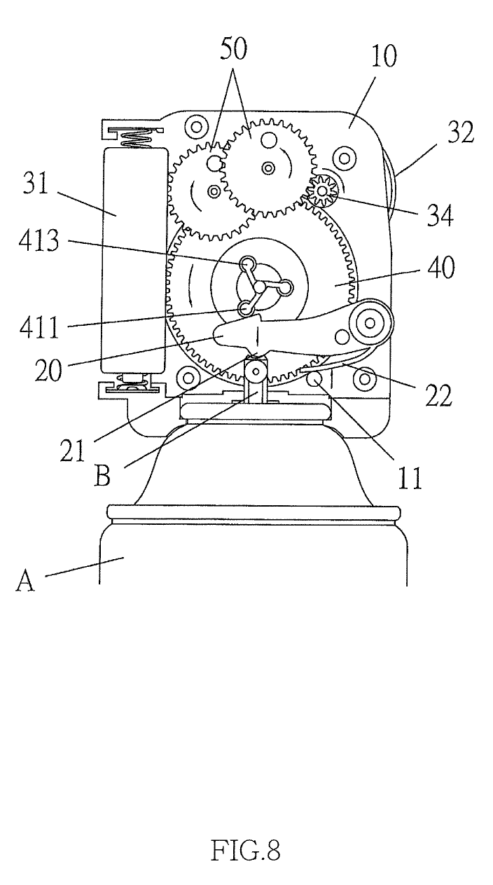

Referring to FIGS. 7 and 8, a spray can A can be fit, through the recess 61 of the second housing 60, into the fitting opening 12 of the first housing 10. The spray can A has a top to which a spraying head or actuator B is mounted. The spraying head B is located under the protrusion 21 of the press bar 20. In the instant embodiment, the protrusion 21 is set in contact engagement with the spraying head B.

The motor 32 is activated at the first activation time point by the circuit control unit 30. In the instant embodiment, two third gears 50 are provided. The third gears 50 are in engagement with each other and the third gears 50 respectively mate the first gear 34 and the second gear 40, whereby the first gear 34 drives the third gears 50 and the third gears 50 in turn drive the second gear 40.

When the second gear 40 rotates, the cam 41 rotates in unison therewith so that the first push member 411 of the cam 41 drive the press bar 20 down to have the protrusion 21 presses against the spraying head B, thereby making the spray can A spray. At this moment, the first push member 411 of the cam 40 keeps on rotating until it contacts and triggers the switching element 33 to shut down the operation of the motor 32 so that the restoration spring force of the elastic element 22 makes the press bar 20 returns to the original position thereby completing a first time of pressing down the spraying head B of the spray can A.

Further, when the restoration spring force of the elastic element 22 returns the press bar 20 to the original position, the circuit control unit 30 activates the motor 32 at the second activation time point, when the first push member 411 moves away from the switching element 33 already, whereby the second push member 412 drives the press bar 20 down again, making the spray can A spray again and thus, a cycle of operation can be completed in this way.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A cyclic pressing-down gear arrangement, comprising:
a hollow first housing, which has an end adapted to communicate with an outside environment, the first housing comprising a stop mounted therein at a predetermined position, the end of the first housing that communicates with the outside environment comprising a fitting opening formed therein, adapted to receive a spray can having a top to which a spraying head is mounted to fit therein;
a press bar, which is rotatably mounted in the first housing and comprises a protrusion and an elastic element, the protrusion being located above the spraying head, the elastic element having an end supported on the stop;
a circuit control unit, which is electrically connected with a power supply, a motor, and a switching element, the motor comprising a rotation spindle, the rotation spindle extending into the first housing, the rotation spindle comprising a first gear mounted thereto, the switching element being set at a predetermined location with respect to the press bar, the circuit control unit being provided with at least a first activation time point and at least a second activation time point so that the circuit control unit is operable to activate the motor at the first activation time point; and
a second gear, which is rotatably mounted in the first housing and is operatively coupled to the first gear, the second gear comprising at least one cam mounted thereto to be in contact engagement with the press bar, whereby when the motor is activated, the first gear drives the second gear to cause the cam to drive the press bar down so that the protrusion presses the spraying head to make the spray can spray and when the cam is rotated to contact and trigger the switching element, the motor is shut down and a restoration spring force of the elastic element drives the press bar to return.

2. The cyclic pressing-down gear arrangement according to claim 1, wherein the first housing comprises at least a third gear mounted therein to mate the first gear and the second gear, whereby the first gear drives the third gear and the third gear in turn drives the second gear.

3. The cyclic pressing-down gear arrangement according to claim 1, wherein the first housing is provided, on outside thereof, with and enclosed by a second housing, the second housing comprising a recess formed to correspond to the fitting opening, the motor and the circuit control unit being received in a space between the first housing and the second housing.

4. The cyclic pressing-down gear arrangement according to claim 1, wherein the circuit control unit comprises a display element.

5. The cyclic pressing-down gear arrangement according to claim 3, wherein the circuit control unit comprises a display element.

6. The cyclic pressing-down gear arrangement according to claim 1, wherein the cam is mounted to and raised from a central portion of the second gear and comprises a first push member, a second push member, and a third push member.

7. The cyclic pressing-down gear arrangement according to claim 1, wherein after the press bar is returned by the restoration spring force of the elastic element, the circuit control unit activates the motor at the second activation time point to thereby achieve a cyclic operation.
